(19) United States
(12) Patent Application Publication
(10) Pub. No.: US 2026/0279287 A1
(43) Pub. Date: Sep. 17, 2026

(54) DISPLAY DEVICE AND ELECTRONIC DEVICE INCLUDING THE SAME

(71) Applicant: Samsung Display Co., Ltd., Yongin-Si (KR)

(72) Inventors: Junki Jeong, Yongin-si (KR); Youngwan Seo, Yongin-si (KR); Jongyeop An, Yongin-si (KR)

(21) Appl. No.: 19/409,774

(22) Filed: Dec. 5, 2025

(30) Foreign Application Priority Data
Mar. 11, 2025 (KR) 10-2025-0031447
May 26, 2025 (KR) 10-2025-0068479

(51) Int. Cl. G09G 3/3266

(52) U.S. Cl. CPC G09G 3/3266; G09G 2300/0819; G09G 2330/023

(57) ABSTRACT

A display device includes: a substrate including display and peripheral areas, first through eighth pixels disposed in the display area of the substrate, and disposed side by side in a first direction, a first gate driver disposed in the peripheral area of the substrate, and sequentially applying a gate write signal to each of the first through eighth pixels along the first direction, and a second gate driver disposed in the peripheral area of the substrate, spaced apart from the first gate driver in a second direction intersecting the first direction, and including: a gate initialization part which simultaneously applies a gate initialization signal to at least two pixels among the first through eighth pixels, and an emission controller which simultaneously applies an emission control signal to at least two pixels among the first through eighth pixels, and disposed adjacent to the gate initialization part in the first direction.

### CROSS-REFERENCE TO RELATED APPLICATION

This application claims priority to and benefits of Korean Patent Application No. 10-2025-0031447 under 35 U.S.C. § 119, filed on Mar. 11, 2025 and Korean Patent Application No. 10-2025-0068479 under 35 U.S.C. § 119, filed on May 26, 2025 in the Korean Intellectual Property Office (KIPO), the entire contents of which are hereby incorporated by reference.

### BACKGROUND

### 1. TECHNICAL FIELD

Embodiments provide generally to a display device and an electronic device including the same. More particularly, embodiments relate to the display device which provides visual information and the electronic device including the same.

### 2. DESCRIPTION OF THE RELATED ART

To drive a display device using a light-emitting element such as an organic light-emitting diode, a gate driver and the like may be disposed in a peripheral area of the display device. In order to reduce the size of the peripheral area in the display device, it is necessary to reduce the size of the gate driver and the like, and efficiently arrange the configuration.

In addition, as the display device becomes more highly integrated and consumes greater power, the need for improving the efficiency of clock lines, voltage lines, and the like in driving the display device is increasing. Accordingly, various studies are being conducted to reduce the size of the peripheral area and to enhance the power efficiency of the display device.

### SUMMARY

Embodiments provide a display device having a reduced size of a peripheral area and enhanced power efficiency.

Embodiments provide an electronic device including the display device.

A display device according to an embodiment of the present disclosure includes a substrate including a display area and a peripheral area surrounding the display area, first, second, third, fourth, fifth, sixth, seventh, and eighth pixels disposed in the display area of the substrate, and disposed side by side in a first direction, a first gate driver disposed in the peripheral area of the substrate, and sequentially applying a gate write signal to each of the first, second, third, fourth, fifth, sixth, seventh, and eighth pixels along the first direction, and a second gate driver disposed in the peripheral area of the substrate, spaced apart from the first gate driver in a second direction intersecting the first direction, and including: a gate initialization part simultaneously applying a gate initialization signal to at least two pixels among the first, second, third, fourth, fifth, sixth, seventh, and eighth pixels and an emission controller simultaneously applying an emission control signal to at least two pixels among the first, second, third, fourth, fifth, sixth, seventh, and eighth pixels, and disposed adjacent to the gate initialization part in the first direction.

In an embodiment, the gate initialization part may include an initialization signal controller and first, second, third, fourth, fifth, sixth, seventh, and eighth initialization signal output parts connected to the initialization signal controller. The emission controller may include an emission signal controller and first, second, third, fourth, fifth, sixth, seventh, and eighth emission signal output parts connected to the emission signal controller.

In an embodiment, the display device may further include first, second, third, fourth, fifth, sixth, seventh, and eighth gate initialization lines extending in an opposite direction of the second direction from the gate initialization part, respectively being connected to the first, third, fourth, fifth, sixth, seventh, and eighth initialization signal output parts, and simultaneously applying the gate initialization signal to the first, second, third, fourth, fifth, sixth, seventh, and eighth pixels, and first, second, third, fourth, fifth, sixth, seventh, and eighth emission control lines extending in the opposite direction of the second direction from the emission controller, respectively being connected to the first, third, fourth, fifth, sixth, seventh, and eighth emission signal output parts, and simultaneously applying the emission control signal to the first, second, third, fourth, fifth, sixth, seventh, and eighth pixels.

In an embodiment, the display device may further include a first clock line disposed in the peripheral area of the substrate and applying a first clock signal to the gate initialization part, and a second clock line disposed in the peripheral area of the substrate and applying a second clock signal to the gate initialization part.

In an embodiment, the first clock line and the second clock line may be electrically connected to the emission controller.

In an embodiment, the display device may further include a third clock line disposed in the peripheral area of the substrate and applying a third clock signal to the emission controller, and a fourth cock line disposed in the peripheral area of the substrate and applying a fourth clock signal to the emission controller.

In an embodiment, the display device may further include a first voltage line disposed in the peripheral area of the substrate and applying a first voltage to the gate initialization part, and a second voltage line disposed in the peripheral area of the substrate and applying a second voltage to the gate initialization part.

In an embodiment, the first voltage line and the second voltage line may be electrically connected to the emission controller.

In an embodiment, the display device may further include a third voltage line disposed in the peripheral area of the substrate and applying a third voltage to the emission controller, and a fourth voltage line disposed in the peripheral area of the substrate and applying a fourth voltage to the emission controller.

In an embodiment, the gate initialization part may include an initialization signal controller and first, second, third, and fourth initialization signal output parts connected to the initialization signal controller. The emission controller includes an emission signal controller and first, second, third, and fourth emission signal output parts connected to the emission signal controller.

In an embodiment, the display device may further include first, second, third, and fourth gate initialization lines extending in an opposite direction of the second direction from the gate initialization part, respectively being connected to the first, second, third, and fourth initialization signal output parts, and simultaneously applying the gate initialization signal to the first, second, third, and fourth pixels, and first, second, third, and fourth emission control lines extending in the opposite direction of the second direction from the emission controller, respectively being connected to the first, second, third, and fourth emission signal output parts, and simultaneously applying the emission control signal to the first, second, third, and fourth pixels.

In an embodiment, the first gate driver may have a first width in the second direction, the second gate driver may have a second width in the second direction, and a sum of the first width and the second width may be 1300 um or more and 1650 um or less.

In an embodiment, the first width may be 450 um or more and 750 um or less.

A display device according to an embodiment of the present disclosure includes a substrate including a display area and a peripheral area surrounding to the display area, first, second, third, fourth, fifth, sixth, seventh, and eighth pixels disposed in the display area of the substrate, and disposed side by side in a first direction, a gate driver disposed in the peripheral area of the substrate, and sequentially applying a gate write signal to each of the first, second, third, fourth, fifth, sixth, seventh, and eighth pixels, a gate initialization part disposed in the peripheral area of the substrate, spaced apart from the gate driver in a second direction interesting the first direction, and simultaneously applying a gate initialization signal to at least two pixels among the first, second, third, fourth, fifth, sixth, seventh, and eighth pixels, and an emission controller disposed in the peripheral area of the substrate, spaced apart from the gate driver with the display area interposed between the emission controller and the gate driver, and simultaneously applying an emission control signal to at least two pixels among the first, second, third, fourth, fifth, sixth, seventh, and eighth pixels.

In an embodiment, the gate initialization part may include an initialization signal controller and first, second, third, fourth, fifth, sixth, seventh, and eighth initialization signal output parts connected to the initialization signal controller. The emission controller may include an emission signal controller and first, second, third, fourth, fifth, sixth, seventh, and eighth emission signal output parts connected to the emission signal controller.

In an embodiment, the display device may further include first, second, third, fourth, fifth, sixth, seventh, and eighth gate initialization lines extending in an opposite direction of the second direction from the gate initialization part, respectively being connected to the first, third, fourth, fifth, sixth, seventh, and eighth initialization signal output parts, and simultaneously applying the gate initialization signal to the first, second, third, fourth, fifth, sixth, seventh, and eighth pixels, and first, second, third, fourth, fifth, sixth, seventh, and eighth emission control lines extending in the opposite direction of the second direction from the emission controller, respectively being connected to the first, third, fourth, fifth, sixth, seventh, and eighth emission signal output parts, and simultaneously applying the emission control signal to the first, second, third, fourth, fifth, sixth, seventh, and eighth pixels.

In an embodiment, the gate initialization part may include an initialization signal controller and first, second, third, and fourth initialization signal output parts connected to the initialization signal controller. The emission controller may include an emission signal controller and first, second, third, and fourth emission signal output parts connected to the emission signal controller.

In an embodiment, the display device may further include first, second, third, and fourth gate initialization lines extending in an opposite direction of the second direction from the gate initialization part, respectively being connected to the first, second, third, and fourth initialization signal output parts, and simultaneously applying the gate initialization signal to the first, second, third, and fourth pixels, and first, second, third, and fourth emission control lines extending in the opposite direction of the second direction from the emission controller, respectively being connected to the first, second, third, and fourth emission signal output parts, and simultaneously applying the emission control signal to the first, second, third, and fourth pixels.

In an embodiment, the gate driver may have a first width in the second direction, the gate initialization part may have a second width in the second direction, the emission controller may have a third width in the second direction, and a sum of the first width, the second width, and the third width may be 1300 um or more and 1650 um or less.

An electronic device according to an embodiment of the present disclosure includes a display device and one or more processors which drives the display device. The display device includes: a substrate including a display area and a peripheral area surrounding to the display area, first, second, third, fourth, fifth, sixth, seventh, and eighth pixels disposed in the display area of the substrate, and disposed side by side in a first direction, a first gate driver disposed in the peripheral area of the substrate, and sequentially applying a gate write signal to each of the first, second, third, fourth, fifth, sixth, seventh, and eighth pixels along the first direction, and a second gate driver disposed in the peripheral area of the substrate, spaced apart from the first gate driver in a second direction intersecting the first direction, and including: a gate initialization part simultaneously applying a gate initialization signal to at least two pixels among the first, second, third, fourth, fifth, sixth, seventh, and eighth pixels and an emission controller simultaneously applying an emission control signal to at least two pixels among the first, second, third, fourth, fifth, sixth, seventh, and eighth pixels, and disposed adjacent to the gate initialization part in the first direction.

A display device according to embodiments of the present disclosure may include a substrate including a display area and a peripheral area surrounding to the display area, first, second, third, fourth, fifth, sixth, seventh, and eighth pixels disposed in the display area of the substrate, and disposed side by side in a first direction, a first gate driver disposed in the peripheral area of the substrate, and sequentially applying a gate write signal to each of the first, second, third, fourth, fifth, sixth, seventh, and eighth pixels along the first direction, and a second gate driver disposed in the peripheral area of the substrate, spaced apart from the first gate driver in a second direction intersecting the first direction, and including: a gate initialization part simultaneously applying a gate initialization signal to at least two pixels among the first, second, third, fourth, fifth, sixth, seventh, and eighth pixels and an emission controller simultaneously applying an emission control signal to at least two pixels among the first, second, third, fourth, fifth, sixth, seventh, and eighth pixels, and disposed adjacent to the gate initialization part in the first direction.

Accordingly, since the gate initialization part and the emission controller are disposed adjacent to each other in the first direction, the size of the peripheral area in the second direction may be reduced, thereby improving the space efficiency of the display device. In addition, since the gate initialization part simultaneously applies the gate initialization signals to each of the first, second, third, fourth, fifth, sixth, seventh, and eighth pixels and the emission controller simultaneously applies the emission control signals to the first, second, third, fourth, fifth, sixth, seventh, and eighth pixels, the power efficiency of the gate initialization part and the emission controller may be enhanced.

### BRIEF DESCRIPTION OF THE DRAWINGS

Illustrative, non-limiting embodiments will be more clearly understood from the following detailed description in conjunction with the accompanying drawings.

FIG. 1 is a perspective view illustrating a display device according to an embodiment of the present disclosure.

FIG. 2 is a block diagram illustrating an embodiment of components included in the display device of FIG. 1.

FIG. 3 is a plan view illustrating an embodiment of a gate driver of FIG. 2.

FIG. 4 is a plan view illustrating an embodiment of a gate initialization part of FIG. 3.

FIG. 5 is a plan view illustrating an embodiment of an emission controller of FIG. 3.

FIG. 6 is a plan view illustrating an embodiment of a gate initialization part of FIG. 3.

FIG. 7 is a plan view illustrating an embodiment of an emission controller of FIG. 3.

FIG. 8 is a plan view illustrating an embodiment of a gate initialization part and an emission controller of FIG. 3.

FIG. 9 is a circuit diagram illustrating an embodiment of a pixel of FIG. 2.

FIG. 10 is a cross-sectional view illustrating an embodiment of the pixel of FIG. 2.

FIG. 11 is a plan view illustrating an embodiment of a gate driver of FIG. 2.

FIG. 12 is a block diagram illustrating an electronic device according to an embodiment of the present disclosure.

FIG. 13 is a schematic diagram of an electronic device according to various embodiments of FIG. 12.

### DETAILED DESCRIPTION OF THE EMBODIMENTS

The embodiments of the present disclosure described herein are provided merely for illustrative purposes to explain particular structural and functional features, and are not intended to limit the scope of the disclosure. The embodiments of the present disclosure may be implemented in various forms and should not be construed as limited to those specifically described herein.

The present disclosure is capable of various modifications and may take on various forms. Specific embodiments are illustrated in the drawings and described in detail in the specification. However, this is not intended to limit the disclosure to specific disclosed forms, but to encompass all modifications, equivalents, and alternatives falling within the spirit and technical scope of the present disclosure.

Terms such as "first" and "second" may be used to describe various elements, but such elements should not be limited by these terms. These terms are used merely to distinguish one element from another. For example, a first element may be referred to as a second element without departing from the scope of the present disclosure, and likewise, the second element may also be referred to as the first element.

In case that it is stated that an element is "connected" to another element, it should be understood that the element may be directly connected or linked to the other element or may be indirectly connected through another intervening element. Other expressions describing the relationship between elements, such as “between” and “directly between,” or “adjacent to” and “directly adjacent to,” should be interpreted in the same manner.

The terminology used in this application is for the purpose of describing particular embodiments only and is not intended to limit the inventive concept. As used herein, the singular forms include the plural forms as well, unless the context clearly indicates otherwise. Terms such as "include" and "have" as used herein specify the presence of stated features, steps, operations, components, or combinations thereof, but do not preclude the presence or addition of one or more other features, steps, operations, components, or combinations thereof.

Terms such as “below,” “under,” “lower,” “beneath,” “above,” “upper,” “on,” and the like are used to describe the relative positional relationships of components illustrated in the drawings. These terms are relative concepts and are explained based on the orientations shown in the drawings.

The term “about” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value.

Unless otherwise defined, all technical and scientific terms used herein have the same meanings as commonly understood by one of ordinary skill in the art to which this inventive concept pertains. Terms defined in commonly used dictionaries should be interpreted as having meanings consistent with the context of the relevant technical field and should not be interpreted in an overly idealized or overly formal sense unless explicitly defined herein.

Hereinafter, embodiments of the present disclosure will be explained in detail with reference to the accompanying drawings. The same reference numerals are used for the same components in the drawings, and redundant descriptions of the same components will be omitted.

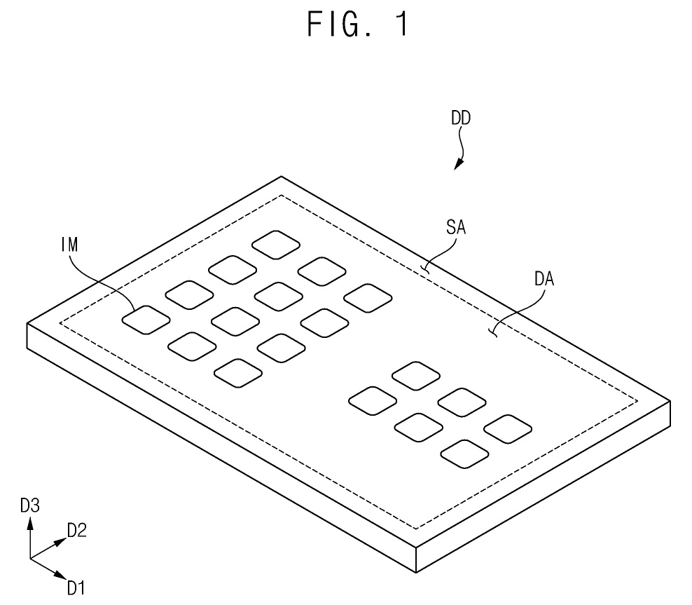

In the present specification, referring to FIG. 1 for example, a plane may be defined by a first direction D1 and a second direction D2 intersecting the first direction D1. For example, the second direction D2 may be perpendicular to the first direction D1. In addition, a third direction D3 may be a normal direction of the plane. That is, the third direction D3 may be perpendicular to the plane defined by the first direction D1 and the second direction D2.

FIG. 1 is a perspective view illustrating a display device DD according to an embodiment of the present disclosure.

Referring to FIG. 1, the display device DD may include a display area DA and a peripheral area SA. The display area DA may be at least partially surrounded by the peripheral area SA.

The display area DA may be an area capable of displaying an image by generating light or by controlling the transmittance of light provided from an external light source. The peripheral area SA may be an area which does not display images. However, the embodiments of the present disclosure are not necessarily limited thereto, and at least a portion of the peripheral area SA may display images.

The display area DA may display a plurality of images IM. Through the plurality of images IM, users may receive information from the display device DD.

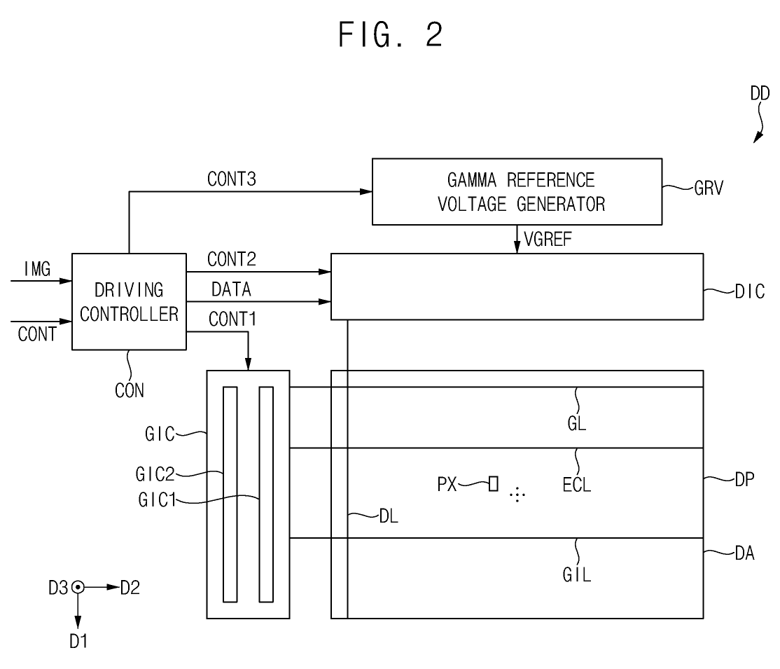

FIG. 2 is a block diagram illustrating an embodiment of the components included in the display device DD of FIG. 1.

Referring to FIGS. 1 and 2, the display device DD may include a display panel DP and display panel drivers. The display panel drivers may include a driving controller CON, a gate driver GIC, a gamma reference voltage generator GRV, and a data driver DIC.

The display area DA of the display panel DP of the display device DD may include a plurality of gate lines GL, a plurality of data lines DL, a plurality of emission control lines ECL, and a plurality of pixels PX electrically connected to each of the gate lines GL, the data lines DL, and the emission control lines ECL.

The gate lines GL may extend in the second direction D2 from the gate driver GIC and may be spaced apart from each other along the first direction D1. The data lines DL may extend in the first direction D1 from the data driver DIC and may be spaced apart from each other along the second direction D2. The emission control lines ECL may extend in a direction opposite to the second direction D2 from the gate driver GIC and may be spaced apart from each other along the first direction D1.

The driving controller CON may receive an input image data IMG and an input control signals CONT from an external device. For example, the input image data IMG may include red image data, green image data, and blue image data. The input image data IMG may include white image data. The input image data IMG may include magenta image data, yellow image data, and cyan image data. The input control signals CONT may include a master clock signal and a data enable signal. The input control signals CONT may further include a vertical sync signal and a horizontal sync signal.

The driving controller CON may generate a first control signal CONT1, a second control signal CONT2, a third control signal CONT3, and a data signal DATA based on the input image data IMG and the input control signals CONT.

The driving controller CON may generate the first control signal CONT1 to control the operation of the gate driver GIC based on the input control signals CONT, and output the first control signal CONT1 to the gate driver GIC. The first control signal CONT1 may include a scan start signal, a gate clock signal, an emission control signal, a gate initialization signal, and the like.

The driving controller CON may generate the second control signal CONT2 to control the operation of the data driver DIC based on the input control signals CONT, and output the second control signal CONT2 to the data driver DIC. The second control signal CONT2 may include a horizontal start signal, a load signal, and the like.

The driving controller CON may generate the data signal DATA based on the input image data IMG. The driving controller CON may output the data signal DATA to the data driver DIC.

The driving controller CON may generate the third control signal CONT3 to control the operation of the gamma reference voltage generator GRV based on the input control signal CONT, and output the third control signal CONT3 to the gamma reference voltage generator GRV.

The gate driver GIC may generate gate signals and emission control signals to drive the display panel DP in response to the first control signal CONT1 received from the driving controller CON. The gate driver GIC may output the gate signals and emission control signals to the gate lines GL and the emission control lines ECL, respectively.

In an embodiment, the gate driver GIC may include a first gate driver GIC1 and a second gate driver GIC2. The second gate driver GIC2 may be disposed spaced apart from the first gate driver GIC2 in an opposite direction of the second direction D2.

The gamma reference voltage generator GRV may generate a gamma reference voltage VGREF in response to the third control signal CONT3 received from the driving controller CON. The gamma reference voltage generator GRV may provide the gamma reference voltage VGREF to the data driver DIC. The gamma reference voltage VGREF may correspond to the respective data signals DATA.

For example, the gamma reference voltage generator GRV may be disposed inside the driving controller CON or inside the data driver DIC.

The data driver DIC may receive the second control signal CONT2 and the data signal DATA from the driving controller CON, and may receive the gamma reference voltage VGREF from the gamma reference voltage generator GRV. The data driver DIC may convert the data signal DATA into an analog-form data voltage using the gamma reference voltage VGREF. The data driver DIC may output the data voltage to each of the data lines DL.

For convenience of explanation in FIG. 2, the gate driver GIC is illustrated as being spaced apart from the display area DA in a direction opposite to the second direction D2, and the data driver DIC is illustrated as being spaced apart from the display area DA in a direction opposite to the first direction D1. However, the present disclosure is not necessarily limited thereto.

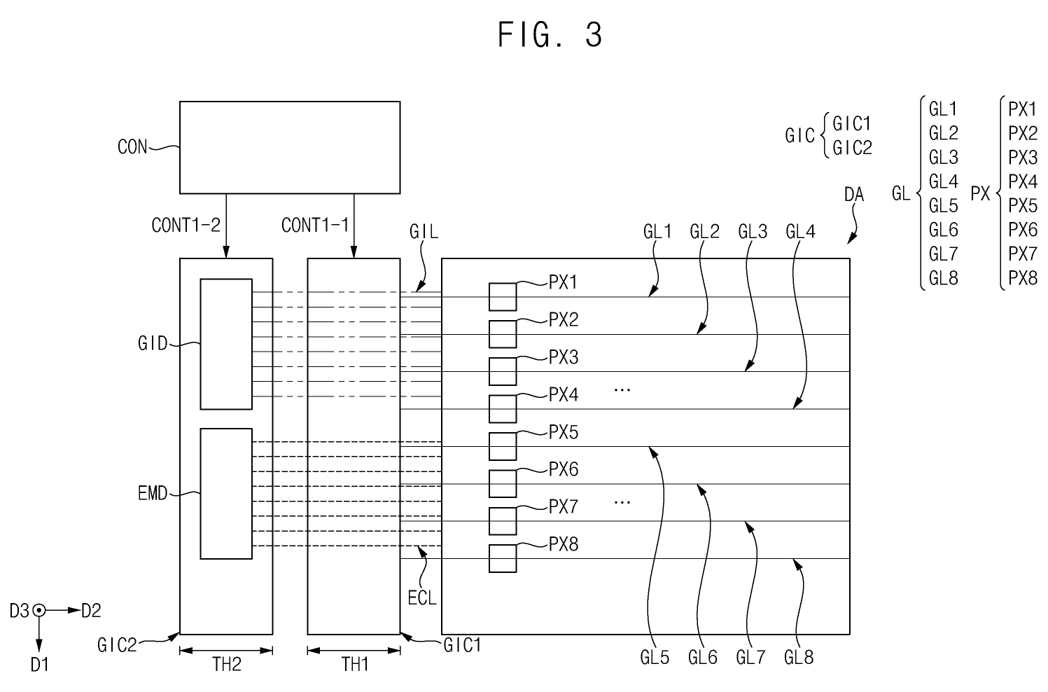

FIG. 3 is a plan view illustrating an embodiment of a gate driver of FIG. 2.

Referring to FIGS. 2 and 3, the pixel PX may include first, second, third, fourth, fifth, sixth, seventh, and eighth pixels PX1, PX2, PX3, PX4, PX5, PX6, PX7, and PX8 disposed along the first direction D1. The gate lines GL may include first, second, third, fourth, fifth, sixth, seventh, and eighth gate lines GL1, GL2, GL3, GL4, GL5, GL6, GL7, and GL8. The second gate driver GIC2 may include a gate initialization part GID and an emission controller EMD. FIG. 3 illustrates the first, second, third, fourth, fifth, sixth, seventh, and eighth pixels PX1, PX2, PX3, PX4, PX5, PX6, PX7, and PX8 disposed side by side in the first direction D1. In an embodiment, the first, second, third, fourth, fifth, sixth, seventh, and eighth pixels PX1, PX2, PX3, PX4, PX5, PX6, PX7, and PX8 may be disposed in a diagonal or zigzag pattern.

The first control signal CONT1 applied from the driving controller CON may include a first-first control signal CONT1-1 and a first-second control signal CONT1-2. Specifically, the driving controller CON may apply the first-first control signal CONT1-1 to the first gate driver GIC1, and apply the first-second control signal CONT1-2 to the second gate driver GIC2.

The first, second, third, fourth, fifth, sixth, seventh, and eighth gate lines GL1, GL2, GL3, GL4, GL5, GL6, GL7, and GL8 may extend in the second direction D2 from the first gate driver GIC1, be disposed in the display area DA, and sequentially apply gate write signals to each of the first, second, third, fourth, fifth, sixth, seventh, and eighth pixels PX1, PX2, PX3, PX4, PX5, PX6, PX7, and PX8. Specifically, the first gate driver GIC1 may apply the gate write signals to the first, second, third, fourth, fifth, sixth, seventh, and eighth gate lines GL1, GL2, GL3, GL4, GL5, GL6, GL7, and GL8 according to the first sub-control signal CONT1-1, and the first, second, third, fourth, fifth, sixth, seventh, and eighth gate lines GL1, GL2, GL3, GL4, GL5, GL6, GL7, and GL8 may sequentially apply the gate write signals to the first, second, third, fourth, fifth, sixth, seventh, and eighth pixels PX1, PX2, PX3, PX4, PX5, PX6, PX7, and PX8. In FIG. 3, the gate lines GL are illustrated as including eight gate lines, but the gate lines GL may include seven or fewer or nine or more gate lines to drive a plurality of pixels.

The gate initialization part GID and the emission controller EMD may be disposed adjacent to each other in the first direction D1. That is, the emission controller EMD may be disposed adjacent to the gate initialization part GID in the first direction D1. In FIG. 3, the second gate driver GIC2 is illustrated as including one gate initialization part and one light emission controller, but the embodiment of the present disclosure is not limited thereto.

The second gate driver GIC2 may include two or more gate initialization parts and two or more emission controllers. In case that the second gate driver GIC2 includes two or more gate initialization parts and two or more emission controllers, the gate initialization parts and the emission controllers may be alternately disposed along the first direction D1.

Gate initialization lines GIL which extend in the second direction D2 from the gate initialization part GID and simultaneously apply the gate initialization signals to at least two among the first, second, third, fourth, fifth, sixth, seventh, and eighth pixels PX1, PX2, PX3, PX4, PX5, PX6, PX7, and PX8 may disposed in the display area DA. That is, the gate initialization lines GIL extending from one gate initialization part GID may simultaneously apply the gate initialization signals. For example, the gate initialization lines GIL may simultaneously apply the gate initialization signals to the first, second, third, fourth, fifth, sixth, seventh, and eighth pixels PX1, PX2, PX3, PX4, PX5, PX6, PX7, and PX8.

The emission control lines ECL which extend in the second direction D2 from the emission controller EMD and simultaneously apply the emission control signals to at least two among the first, second, third, fourth, fifth, sixth, seventh, and eighth pixels PX1, PX2, PX3, PX4, PX5, PX6, PX7, and PX8. That is, the emission control lines ECL extending from one emission controller EMD may simultaneously apply the emission control signals. For example, the emission control lines ECL may simultaneously apply emission control signals to the first, second, third, fourth, fifth, sixth, seventh, and eighth pixels PX1, PX2, PX3, PX4, PX5, PX6, PX7, and PX8.

In an embodiment, the first gate driver GIC1 may have a first width TH1 in the second direction D2. The second gate driver GIC2 may have a second width TH2 in the second direction D2.

For example, the first width TH1 of the first gate driver GIC1 may be about 850 μm or more to about 900 μm or less. Suitably, the first width TH1 may be about 800 μm or more to about 900 μm or less. The second width TH2 of the second gate driver GIC2 may be about 450 μm or more to about 750 μm or less. Suitably, the second width TH2 may be about 500 μm or more to about 750 μm or less.

Because the second gate driver GIC2 includes the gate initialization part GID and the emission controller EMD disposed adjacent to each other in the first direction D1, the second width TH2 of the second gate driver GIC2 in the second direction D2 may satisfy the above-described range. Accordingly, the width of the peripheral area (e.g., the peripheral area SA of FIG. 1) of the display device DD in the second direction D2 may be reduced compared to a case where the gate initialization part GID and the emission controller EMD are spaced apart in the second direction D2.

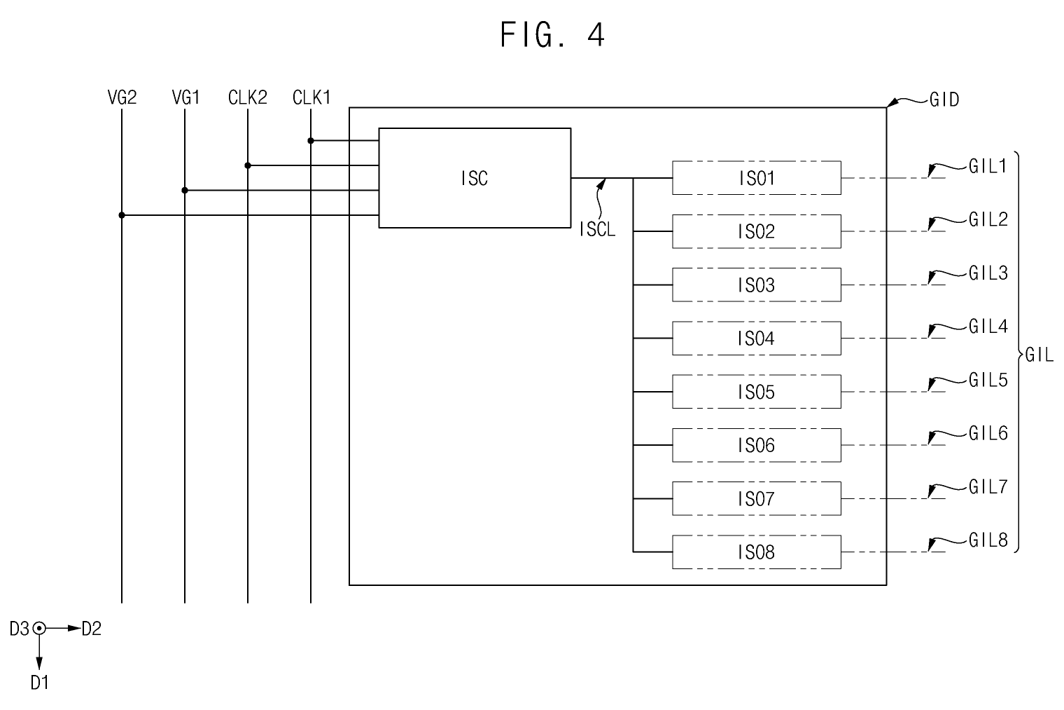

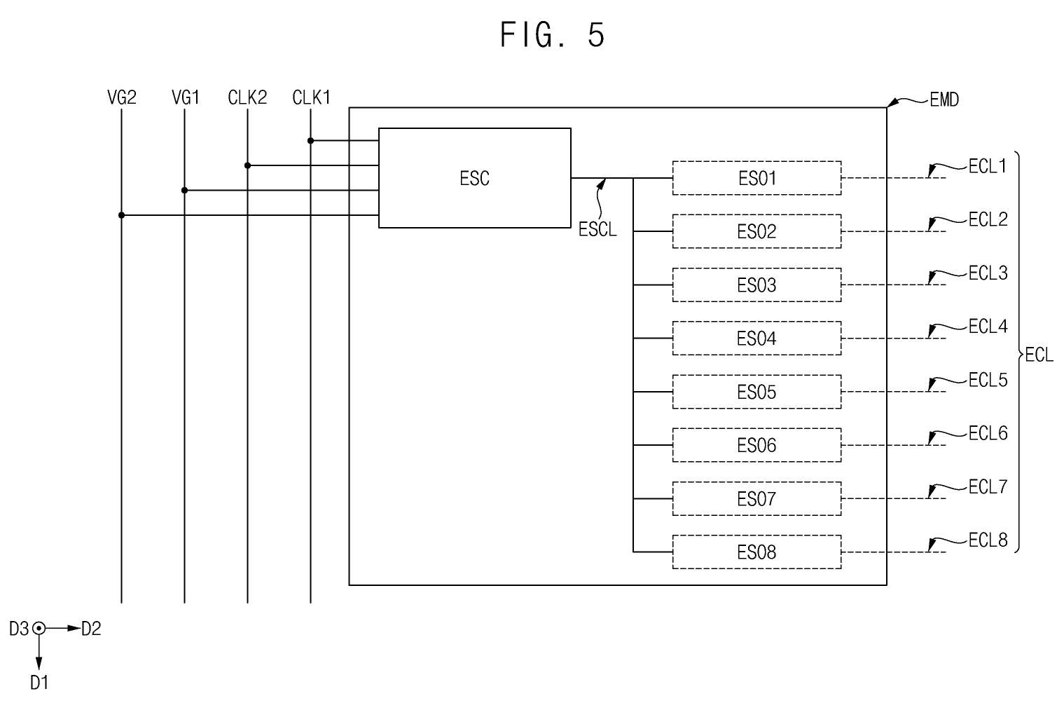

FIG. 4 is a plan view illustrating an embodiment of the gate initialization part GID of FIG. 3. FIG. 5 is a plan view illustrating an embodiment of the emission controller EMD of FIG. 3.

Referring to FIGS. 3 and 4, the gate initialization part GID may include an initialization signal controller ISC and first, second, third, fourth, fifth, sixth, seventh, and eighth initialization signal output parts ISO1, ISO2, ISO3, ISO4, ISO5, ISO6, ISO7, and ISO8 electrically connected to the initialization signal controller ISC. The first, second, third, fourth, fifth, sixth, seventh, and eighth initialization signal output parts ISO1, ISO2, ISO3, ISO4, ISO5, ISO6, ISO7, and ISO8 may be sequentially disposed along the first direction D1 inside the gate initialization part GID. The initialization signal controller ISC may include a shift register, a signal selector, and the like.

The first, second, third, fourth, fifth, sixth, seventh, and eighth initialization signal output parts ISO1, ISO2, ISO3, ISO4, ISO5, ISO6, ISO7, and ISO8 may be connected to the initialization signal controller ISC through an initialization signal connection line ISCL. The initialization signal controller ISC may simultaneously apply control signals to the first, second, third, fourth, fifth, sixth, seventh, and eighth initialization signal output parts ISO1, ISO2, ISO3, ISO4, ISO5, ISO6, ISO7, and ISO8 through the initialization signal connection lines ISCL.

The gate initialization lines GIL may include first, second, third, fourth, fifth, sixth, seventh, and eighth gate initialization lines GIL1, GIL2, GIL3, GIL4, GIL5, GIL6, GIL7, and GIL8. The first, second, third, fourth, fifth, sixth, seventh, and eighth gate initialization lines GIL1, GIL2, GIL3, GIL4, GIL5, GIL6, GIL7, and GIL8 may extend in the second direction D2 from each of the first, second, third, fourth, fifth, sixth, seventh, and eighth initialization signal output parts ISO1, ISO2, ISO3, ISO4, ISO5, ISO6, ISO7, and ISO8. The first, second, third, fourth, fifth, sixth, seventh, and eight initialization signal output parts ISO1, ISO2, ISO3, ISO4, ISO5, ISO6, ISO7, and ISO8 may be spaced apart from each other in the first direction D1. The first, second, third, fourth, fifth, sixth, seventh, and eighth gate initialization lines GIL1, GIL2, GIL3, GIL4, GIL5, GIL6, GIL7, and GIL8 may apply the gate initialization signals to the first, second, third, fourth, fifth, sixth, seventh, and eighth pixels PX1, PX2, PX3, PX4, PX5, PX6, PX7, and PX8, respectively.

Specifically, the first gate initialization line GIL1 may extend from the first initialization signal output part ISO1 in the second direction D2. The second gate initialization line GIL2 may extend from the second initialization signal output part ISO2 in the second direction D2. The third gate initialization line GIL3 may extend from the third initialization signal output part ISO3 in the second direction D2. The fourth gate initialization line GIL4 may extend from the fourth initialization signal output part ISO4 in the second direction D2. The fifth gate initialization line GIL5 may extend from the fifth initialization signal output part ISO5 in the second direction D2. The sixth gate initialization line GIL6 may extend from the sixth initialization signal output part ISO6 in the second direction D2. The seventh gate initialization line GIL7 may extend from the seventh initialization signal output part ISO7 in the second direction D2. The eighth gate initialization line GIL8 may extend from the eighth initialization signal output part ISO8 in the second direction D2.

In FIG. 4, the gate initialization part GID is illustrated as including eight of the first, second, third, fourth, fifth, sixth, seventh, and eighth initialization signal output parts ISO1, ISO2, ISO3, ISO4, ISO5, ISO6, ISO7, and ISO8, but the embodiment of the present disclosure is not limited thereto. One of initialization signal output parts may be provided, and the first, second, third, fourth, fifth, sixth, seventh, and eighth gate initialization lines GIL1, GIL2, GIL3, GIL4, GIL5, GIL6, GIL7, and GIL8 may extend from the one of the initialization signal output parts.

First and second clock lines CLK1 and CLK2 extending in the first direction D1 and first and second voltage lines VG1 and VG2 extending in the first direction D1 may be disposed in one side of the gate initialization part GID. In FIG. 4, the first and second clock lines CLK1 and CLK2 and the first and second voltage lines VG1 and VG2 are illustrated as being spaced apart from the gate initialization part GID in the second direction D2 in the plan view, but the first and second clock lines CLK1 and CLK2 and the first and second voltage lines VG1 and VG2 may be disposed to overlap the gate initialization part GID in the plan view.

The initialization signal controller ISC may be connected to the first and second clock lines CLK1 and CLK2 to receive clock signals and connected to the first and second voltage lines VG1 and VG2 to receive voltages. Specifically, the initialization signal controller ISC may receive the clock signals through the first and second clock lines CLK1 and CLK2 and the voltages through the first and second voltage lines VG1 and VG2 to control each of the first, second, third, fourth, fifth, sixth, seventh, and eighth initialization signal output parts ISO1, ISO2, ISO3, ISO4, ISO5, ISO6, ISO7, and ISO8.

Referring further to FIG. 5, the emission controller EMD may include an emission signal controller ESC and first, second, third, fourth, fifth, sixth, seventh, and eighth emission signal output parts ESO1, ESO2, ESO3, ESO4, ESO5, ESO6, ESO7, and ESO8 electrically connected to the emission signal controller ESC. The first, second, third, fourth, fifth, sixth, seventh, and eighth emission signal output parts ESO1, ESO2, ESO3, ESO4, ESO5, ESO6, ESO7, and ESO8 may be sequentially disposed along the first direction D1 inside the emission controller EMD. The emission signal controller ESC may include a shift register, a signal selector, and the like.

The first, second, third, fourth, fifth, sixth, seventh, and eighth emission signal output parts ESO1, ESO2, ESO3, ESO4, ESO5, ESO6, ESO7, and ESO8 may be connected to the emission signal controller ESC through an emission signal connection line ESCL. The emission signal controller ESC may simultaneously apply control signals to the first, second, third, fourth, fifth, sixth, seventh, and eighth emission signal output parts ESO1, ESO2, ESO3, ESO4, ESO5, ESO6, ESO7, and ESO8 through the emission signal connection line ESCL.

The emission control line ECL may include first, second, third, fourth, fifth, sixth, seventh, and eighth emission control lines ECL1, ECL2, ECL3, ECL4, ECL5, ECL6, ECL7, and ECL8. The first, second, third, fourth, fifth, sixth, seventh, and eighth emission control lines ECL1, ECL2, ECL3, ECL4, ECL5, ECL6, ECL7, and ECL8 may extend in the second direction D2 from each of the first, second, third, fourth, fifth, sixth, seventh, and eighth emission signal output parts ESO1, ESO2, ESO3, ESO4, ESO5, ESO6, ESO7, and ESO8. The first, second, third, fourth, fifth, sixth, seventh, and eighth emission control lines ECL1, ECL2, ECL3, ECL4, ECL5, ECL6, ECL7, and ECL8 may be spaced apart from each another in the first direction D1. The first, second, third, fourth, fifth, sixth, seventh, and eighth emission control lines ECL1, ECL2, ECL3, ECL4, ECL5, ECL6, ECL7, and ECL8 may apply emission control signals to the first, second, third, fourth, fifth, sixth, seventh, and eighth pixels PX1, PX2, PX3, PX4, PX5, PX6, PX7, and PX8, respectively.

Specifically, the first emission control line ECL1 may extend in the second direction D2 from the first emission signal output part ESO1. The second emission control line ECL2 may extend from the second emission signal output part ESO2. The third emission control line ECL3 may extend from the third emission signal output part ESO3. The fourth emission control line ECL4 may extend from the fourth emission signal output part ESO4. The fifth emission control line ECL5 may extend from the fifth emission signal output part ESO5. The sixth emission control line ECL6 may extend from the sixth emission signal output part ESO6. The seventh emission control line ECL7 may extend from the seventh emission signal output part ESO7. The eighth emission control line ECL8 may extend from the eighth emission signal output part ESO8.

In FIG. 5, the emission controller EMD is illustrated as including eight of the first, second, third, fourth, fifth, sixth, seventh, and eighth emission signal output parts ESO1, ESO2, ESO3, ESO4, ESO5, ESO6, ESO7, and ESO8, the embodiments of the present disclosure are not necessarily limited thereto. One of emission signal output parts may be provided, and the first, second, third, fourth, fifth, sixth, seventh, and eighth emission control lines ECL1, ECL2, ECL3, ECL4, ECL5, ECL6, ECL7, and ECL8 may extend from the one of the emission signal output parts.

The first and second clock lines CLK1 and CLK2 extending in the first direction D1 and the first and second voltage lines VG1 and VG2 may be disposed in one side of the emission controller EMD. In FIG. 5, the first and second clock lines CLK1 and CLK2 and the first and second voltage lines VG1 and VG2 are illustrated as being spaced apart from the emission controller EMD in the second direction D2 in the plan view, but the first and second clock lines CLK1 and CLK2 and the first and second voltage lines VG1 and VG2 may be disposed to overlap the emission controller EMD in the plan view.

The first and second clock lines CLK1 and CLK2 may apply a first clock signal and a second clock signal to the initialization signal controller ISC and the emission signal controller ESC. For example, the first clock signal and the second clock signal may have different phases.

The first voltage line VG1 may receive a first voltage, and the second voltage line VG2 may receive a second voltage. The first voltage and the second voltage may have different levels. For example, the first voltage may be higher than the second voltage. That is, the first voltage may be a high-level voltage and the second voltage may be a low-level voltage.

For example, the emission signal controller ESC may be connected to the first and second clock lines CLK1 and CLK2 to receive the clock signals and connected to the first and second voltage lines VG1 and VG2 to receive the voltages. Specifically, the emission signal controller ESC may receive the clock signals through the first and second clock lines CLK1 and CLK2 and receive the voltages through the first and second voltage lines VG1 and VG2 to control each of the first, second, third, fourth, fifth, sixth, seventh, and eighth emission signal output parts ESO1, ESO2, ESO3, ESO4, ESO5, ESO6, ESO7, and ESO8.

In an embodiment, referring together to FIGS. 4 and 5, the first and second voltage lines VG1 and VG2 may be simultaneously connected to the initialization signal controller ISC and the emission signal controller ESC. Since the first and second voltage lines VG1 and VG2 are connected simultaneously to the initialization signal controller ISC and the emission signal controller ESC, a width of the peripheral area (e.g., the peripheral area SA of FIG. 1) in the second direction D2 may be reduced compared to a case in which the initialization signal controller ISC and the emission signal controller ESC are driven by separate voltage lines.

As a result, as the first, second, third, fourth, fifth, sixth, seventh, and eighth initialization signal output parts ISO1, ISO2, ISO3, ISO4, ISO5, ISO6, ISO7, and ISO8 are connected to one of the initialization signal controller ISC, and the first, second, third, fourth, fifth, sixth, seventh, and eighth emission signal output parts ESO1, ESO2, ESO3, ESO4, ESO5, ESO6, ESO7, and ESO8 are connected to one of the emission controller ESC, the integration efficiency of components disposed inside the second gate driver GIC2 may be improved, and the second width TH2 may be reduced. In addition, as the first, and second clock lines CLK1 and CLK2 and the first and second voltage lines VG1 and VG2 are simultaneously connected to the initialization signal controller ISC and the emission controller ESC, the width of the peripheral area (e.g., the peripheral area SA of FIG. 1) may be reduced, and the power efficiency of the display device DD may be enhanced.

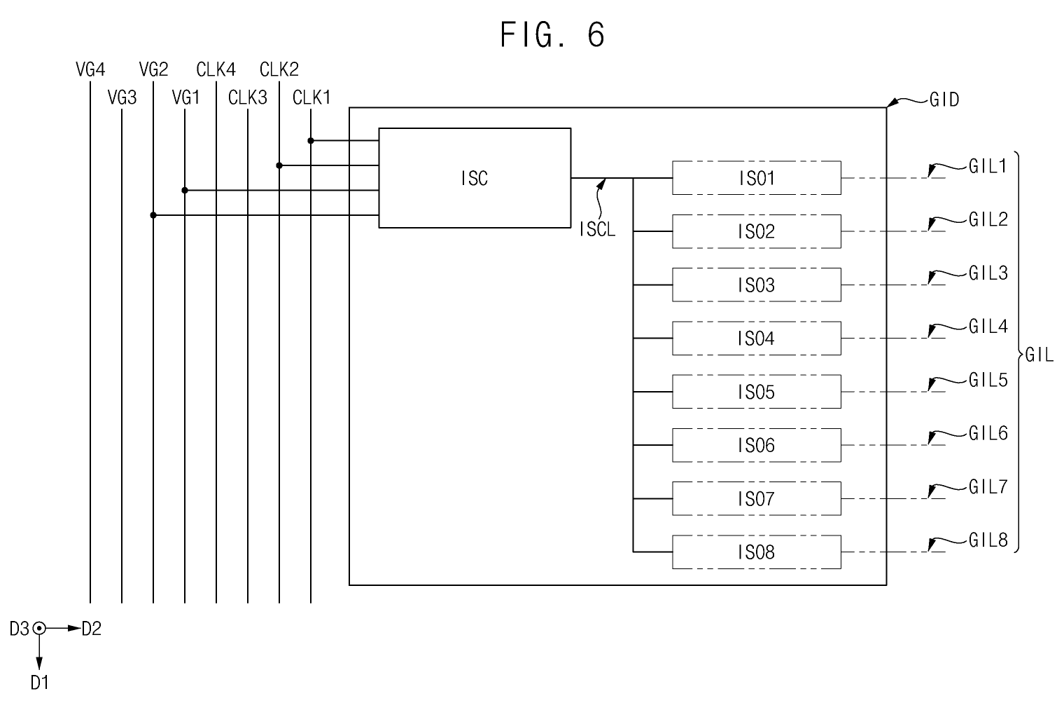

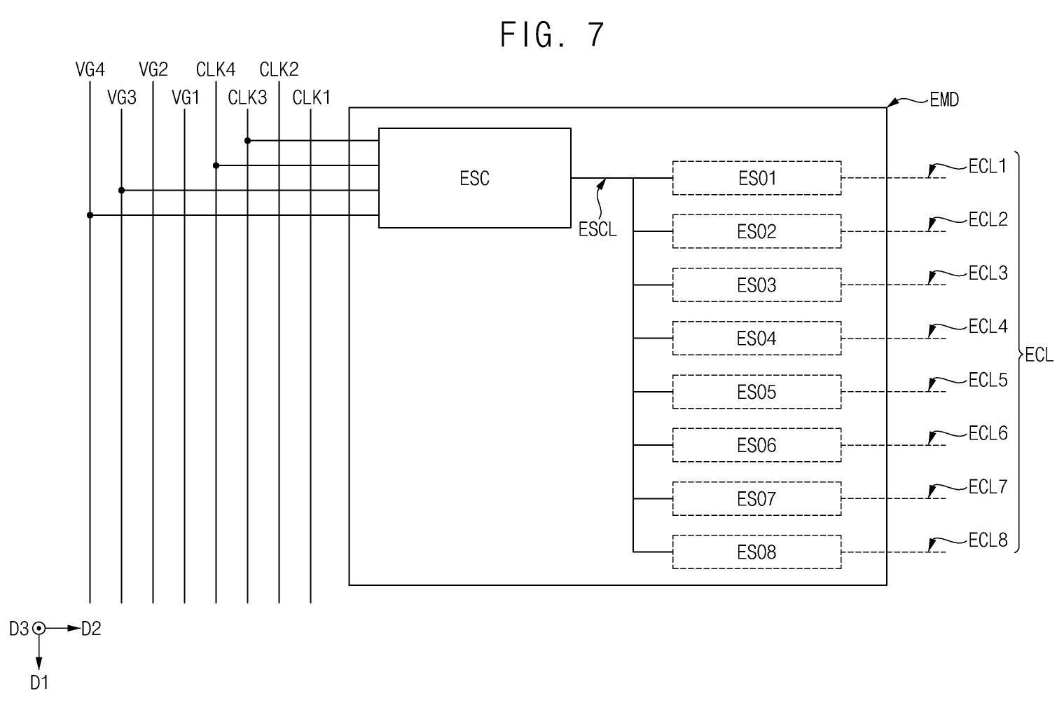

FIG. 6 is a plan view illustrating an embodiment of the gate initialization part GID of FIG. 3. FIG. 7 is a plan view illustrating an embodiment of the emission controller EMD of FIG. 3. Specifically, the description with reference to FIGS. 6 and 7 may be substantially the same as the description with reference to FIGS. 4 and 5, except for third and fourth clock lines CLK3 and CLK4 and third and fourth voltage lines VG3 and VG4. Accordingly, redundant content will be omitted or simplified.

Referring to FIGS. 3, 6 and 7, in one side of the gate initialization part GID and the emission controller EMD, in addition to the first and second clock lines CLK1 and CLK2 extending in the first direction D1, the third and fourth clock lines CLK3 and CLK4 extending in the first direction D1 and spaced apart from the first and second clock lines CLK1 and CLK2 in the second direction D2 may be further disposed. The third clock line CLK3 may receive a third clock signal, and the fourth clock line CLK4 may receive a fourth clock signal. For example, the third clock signal and the fourth clock signal may have different phases.

The first, second, third, and fourth clock lines CLK1, CLK2, CLK3, and CLK4 are illustrated as being spaced from the gate initialization part GID in the second direction D2 in the plan view. In an embodiment, the first, second, third, and fourth clock lines CLK1, CLK2, CLK3, and CLK4 may be disposed to overlap the gate initialization part GID in the plan view.

In an embodiment, the first and second clock lines CLK1 and CLK2 may apply the first and second clock signals to the gate initialization part GID, respectively and the third and fourth clock lines CLK3 and CLK4 may apply third and fourth clock signals to the emission controller EMD, respectively. That is, the gate initialization part GID and the emission controller EMD may be driven by different clock lines. Since the gate initialization part GID is controlled by the first and second clock lines CLK1 and CLK2 and the emission controller EMD is controlled by the third and fourth clock lines CLK3 and CLK4, the signal load applied to each of the first, second, third, and fourth clock lines CLK1 to CLK4 may be reduced compared to the case in which the first, second, third, and fourth clock lines CLK1 to CLK4 simultaneously control the gate initialization part GID and the emission controller EMD.

In one side of the gate initialization part GID and the emission controller EMD, in addition to the first and second voltage lines VG1 and VG2 extending in the first direction D1, the third and fourth voltage lines VG3 and VG4 extending in the first direction D1 and spaced apart from the first and second voltage lines VG1 and VG2 in the second direction D2 may be further disposed. The third voltage line VG3 may receive a third voltage, and the fourth voltage line VG4 may receive a fourth voltage. For example, the third voltage may be higher than the fourth voltage. That is, the third voltage may be a high-level voltage, and the fourth voltage may be a low-level voltage.

The first, second, third, and fourth voltage lines VG1, VG2, VG3, and VG4 are illustrated as being spaced from the gate initialization part GID in the second direction D2 in the plan view. In an embodiment, the first, second, third, and fourth voltage lines VG1, VG2, VG3, and VG4 may be disposed to overlap the gate initialization part GID in the plan view.

In FIG. 6, the first, second, third, and fourth clock lines CLK1, CLK2, CLK3, and CLK4 and the first, second, third, and fourth voltage lines VG1, VG2, VG3, and VG4 are illustrated as being disposed, but the embodiments of the present disclosure are not necessarily limited thereto. The clock lines may include the first, second, third, and fourth clock lines CLK1, CLK2, CLK3, and CLK4, and the voltage lines may include only the first and second voltage lines VG1 and VG2. Conversely, the clock lines may include only the first and second clock lines CLK1 and CLK2, and the voltage lines may include the first, second, third, and fourth voltage lines VG1, VG2, VG3, and VG4. That is, the number and arrangement of the clock lines and the voltage lines may be selectively adjusted in consideration of the size of the peripheral area SA of the display device DD and power efficiency.

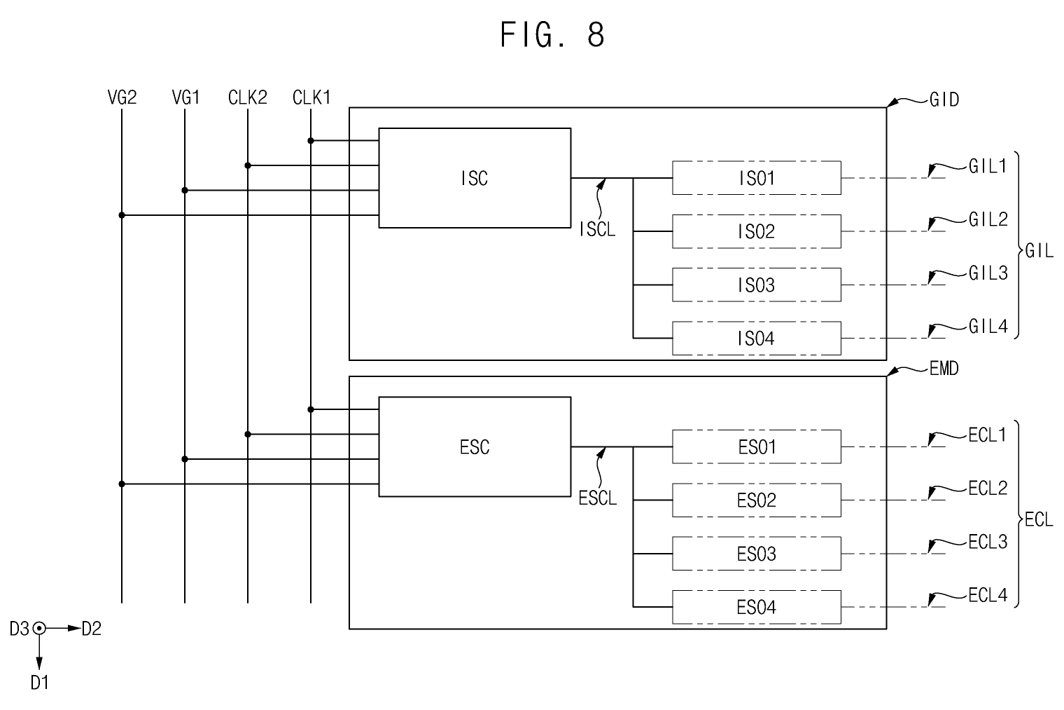

FIG. 8 is a plan view illustrating an embodiment of the gate initialization part GID and the emission controller EMD of FIG. 3. Specifically, the description with reference to FIG. 8 may be substantially the same as the description with reference to FIGS. 4 and 5, except that the gate initialization part GID includes four initialization signal output parts ISO1, ISO2, ISO3, and ISO4 and the emission controller EMD includes four emission signal output parts ESO1, ESO2, ESO3, and ESO4. Accordingly, redundant content will be omitted or simplified.

Referring to FIGS. 3 and 8, the gate initialization part GID may include the initialization signal controller ISC and the first, second, third, and fourth initialization signal output parts ISO1, ISO2, ISO3, and ISO4 electrically connected to the initialization signal controller ISC. The emission controller EMD may include the emission signal controller ESC and the first, second, third, and fourth emission signal output parts ESO1, ESO2, ESO3, and ESO4 electrically connected to the emission signal controller ESC.

In an embodiment, the gate initialization lines GIL may include four of the first, second, third, and fourth gate initialization lines GIL1, GIL2, GIL3, and GIL4. Each of the first, second, third, and fourth gate initialization lines GIL1, GIL2, GIL3, and GIL4 may extend in the second direction D2 from each of the first, second, third, and fourth initialization signal output parts ISO1, ISO2, ISO3, and ISO4. That is, the gate initialization part GID may control the four of the first, second, third, and fourth gate initialization lines GIL1, GIL2, GIL3, and GIL4.

In an embodiment, the emission control lines ECL may include four of the first, second, third, and fourth emission control lines ECL1, ECL2, ECL3, and ECL4. Each of first, second, third, and fourth the emission control lines ECL1, ECL2, ECL3, and ECL4 may extend in the second direction D2 from each of the emission signal output parts ESO1, ESO2, ESO3, and ESO4. That is, the emission controller EMD may control the four of the first, second, third, and fourth the emission control lines ECL1, ECL2, ECL3, and ECL4.

The gate initialization part GID and the emission controller EMD described with reference to FIG. 8 may simultaneously control four lines, respectively. As the gate initialization part GID and the emission controller EMD simultaneously control four lines, respectively, the load of each of the gate initialization lines GIL and the emission control lines ECL may be reduced compared to the cases described with reference to FIGS. 4, 5, 6 and 7.

Accordingly, since the gate initialization part GID and the emission controller EMD are disposed adjacent to each other in the first direction D1, the size of the peripheral area SA (e.g., see FIG. 1) in the second direction D2 may be reduced, thereby improving the space efficiency of the display device DD. The width of the peripheral area SA in the second direction D2 may have within about 3 mm according to the embodiments shown in FIGS. 3, 4, 5, 6, 7 and 8.

In addition, since the gate initialization part GID simultaneously applies the gate initialization signals to each of the first, second, third, fourth, fifth, sixth, seventh, and eighth pixels PX1, PX2, PX3, PX4, PX5, PX6, PX7, and PX8 and the emission controller EMD simultaneously applies the emission control signals to the first, second, third, fourth, fifth, sixth, seventh, and eighth pixels PX1, PX2, PX3, PX4, PX5, PX6, PX7, and PX8, the power efficiency of the gate initialization part GID and the emission controller EMD may be enhanced.

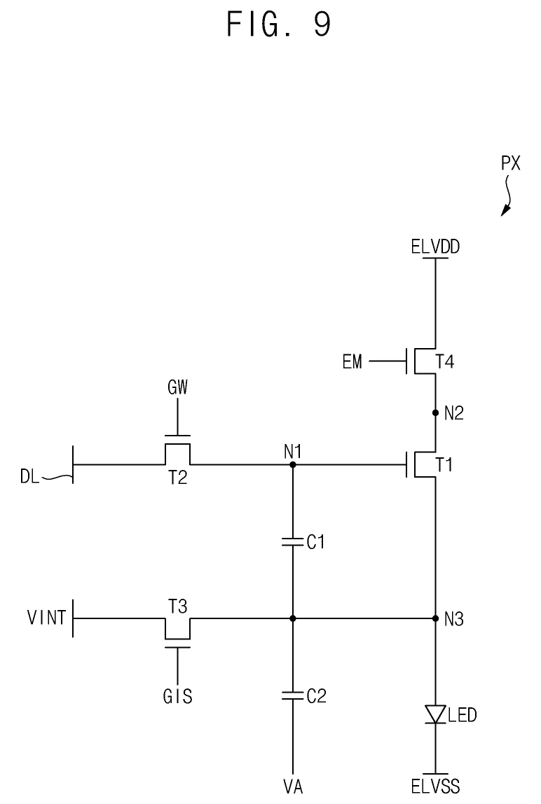

FIG. 9 is a circuit diagram illustrating an embodiment of the pixel PX of FIG. 2.

Referring to FIGS. 2 and 9, the pixel PX may include a first transistor T1, a second transistor T2, a third transistor T3, a fourth transistor T4, a first capacitor C1, a second capacitor C2, and a light-emitting element LED.

In an embodiment, the first transistor T1, the second transistor T2, the third transistor T3, and the fourth transistor T4 may be NMOS transistors.

The NMOS transistor may be turned on in case that a gate-to-source voltage of the NMOS transistor is greater than or equal to a threshold voltage of the NMOS transistor. Conversely, the NMOS transistor may be turned off in case that the gate-to-source voltage is less than the threshold voltage. For example, the NMOS transistor may be turned on in case that a gate signal having a high level is applied to a gate electrode of the NMOS transistor. For example, the NMOS transistor may be turned off in case that a gate signal having a low level is applied to the gate electrode. Therefore, the turn-on level of the NMOS transistor may be the high level, and the turn-off level may be the low level.

A PMOS transistor may be turned on in case that a gate-to-source voltage of the PMOS transistor is less than or equal to a threshold voltage of the PMOS transistor. Conversely, the PMOS transistor may be turned off in case that the gate-to-source voltage is greater than the threshold voltage. For example, the PMOS transistor may be turned on in case that a gate signal having the low level is applied to a gate electrode thereof, and turned off in case that the gate signal has the high level. Therefore, the turn-on level of the PMOS transistor may be the low level, and the turn-off level may be the high level.

The first transistor T1 may include a gate electrode connected to a first node N1, a first electrode connected to a second node N2, and a second electrode connected to a third node N3. The first transistor T1 may be turned on based on a voltage of the first node N1 and a voltage of the third node N3, and may generate a driving current. Specifically, the first transistor T1 may be turned on based on a difference between the voltage of the first node N1 and the voltage of the third node N3 to generate the driving current. Therefore, the greater the difference between the voltage of the first node N1 and the voltage of the third node N3, the greater the magnitude of the driving current may be. For example, the first transistor T1 may be referred to as a driving transistor.

The second transistor T2 may include a gate electrode which receives a data write gate signal GW, a first electrode connected to a data line DL, and a second electrode connected to the first node N1. The second transistor T2 may be turned on in response to the data write gate signal GW having the high level and provide a voltage transmitted through the data line DL to the first node N1. For example, the second transistor T2 may be referred to as a data write transistor.

The third transistor T3 may include a gate electrode which receives an initialization gate signal GIS, a first electrode which receives an initialization voltage VINT, and a second electrode connected to the third node N3. The third transistor T3 may be turned on in response to the initialization gate signal GIS having the high level and provide the initialization voltage VINT to the third node N3. For example, the third transistor T3 may be referred to as an initialization transistor.

The fourth transistor T4 may include a gate electrode which receives an emission signal EM, a first electrode which receives a first power voltage ELVDD, and a second electrode connected to the second node N2. The fourth transistor T4 may be turned on in response to the emission signal EM having the high level to connect a line for providing the first power voltage ELVDD to the second node N2, and may provide the first power supply voltage ELVDD to the second node N2. For example, the fourth transistor T4 may be referred to as an emission control transistor.

The first capacitor C1 may include a first electrode connected to the first node N1 and a second electrode connected to the third node N3.

The second capacitor C2 may include a first electrode which receives a constant voltage VA and a second electrode connected to the third node N3.

The light-emitting element LED may include an anode electrode connected to the third node N3 and a cathode electrode which receives a second power voltage ELVSS. The light-emitting element LED may emit light based on the driving current. The greater the magnitude of the driving current, the greater the luminance corresponding to the light-emitting intensity of the light-emitting element LED.

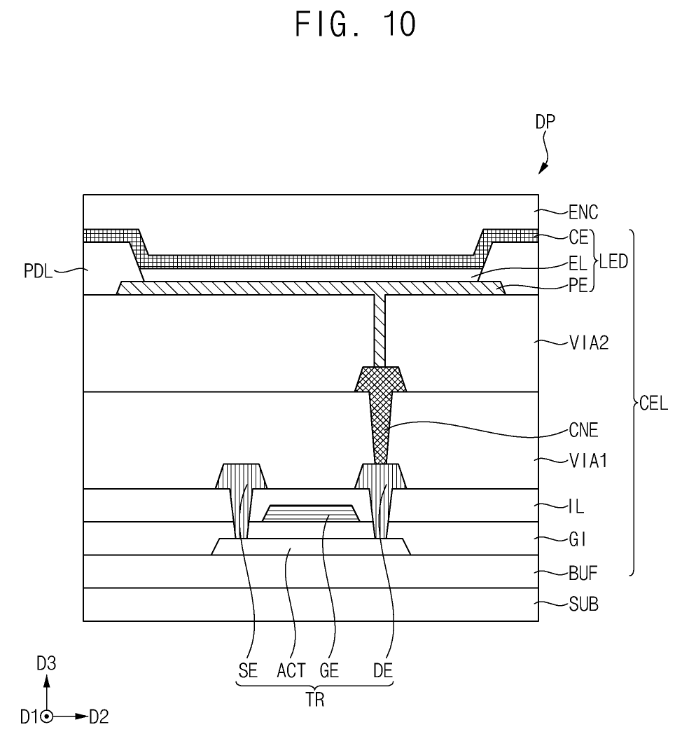

FIG. 10 is a cross-sectional view illustrating an embodiment of the pixel of FIG. 2.

Referring to FIGS. 2 and 10, the pixel PX may include a substrate SUB, a circuit element layer CEL, a light-emitting element LED, and an encapsulation layer ENC. The circuit element layer CEL may include a buffer layer BUF, a gate insulating layer GI, a transistor TR, an interlayer insulating layer IL, a connection electrode CNE, a first via layer VIA1, a second via layer VIA2, the light-emitting element LED, and a pixel defining layer PDL.

The transistor TR may include an active layer ACT, a gate electrode GE, a source electrode SE, and a drain electrode DE. The light-emitting element LED may include a pixel electrode PE, a light-emitting layer EL, and a common electrode CE.

The substrate SUB may include a glass substrate, a metal substrate, or a plastic substrate. For example, the plastic substrate of the substrate SUB may include polyimide. However, the embodiments of the present disclosure are not necessarily limited thereto, and the substrate SUB may be an inorganic layer, an organic layer, or a composite material layer.

The buffer layer BUF may be disposed on the substrate SUB. The buffer layer BUF may prevent impurities such as oxygen or moisture from penetrating to an upper portion of the substrate SUB. The buffer layer BUF may include an inorganic insulating material.

The active layer ACT may be disposed on the buffer layer BUF. The active layer ACT may include an oxide semiconductor, a silicon semiconductor, or an organic semiconductor. For example, the oxide semiconductor may include at least one oxide selected from indium (In), gallium (Ga), tin (Sn), zirconium (Zr), vanadium (V), hafnium (Hf), cadmium (Cd), germanium (Ge), chromium (Cr), titanium (Ti), and zinc (Zn). The silicon semiconductor may include amorphous silicon, polycrystalline silicon, and the like. The active layer ACT may include a source region, a drain region, and a channel region located between the source region and the drain region.

The gate insulating layer GI may be disposed on the buffer layer BUF. Specifically, the gate insulating layer GI may cover the active layer ACT on the buffer layer BUF. The gate insulating layer GI may include an inorganic insulating material. In an embodiment, the gate insulating layer GI may be entirely disposed over the display area DA and the peripheral area SA. In an embodiment, the gate insulating layer GI may be disposed only under the gate electrode GE.

The gate electrode GE may be disposed on the gate insulating layer GI. The gate electrode GE may at least partially overlap the channel region of the active layer ACT. The gate electrode GE may include a conductive material such as metal, alloy, conductive metal nitride, conductive metal oxide, a transparent conductive material, and the like. Examples of such conductive materials may include gold (Au), silver (Ag), aluminum (Al), platinum (Pt), nickel (Ni), titanium (Ti), palladium (Pd), magnesium (Mg), calcium (Ca), lithium (Li), chromium (Cr), tantalum (Ta), tungsten (W), copper (Cu), molybdenum (Mo), scandium (Sc), neodymium (Nd), iridium (Ir), alloy containing Al, alloy containing Ag, alloy containing Cu, alloy containing Mo, aluminum nitride (AlN), tungsten nitride (WN), titanium nitride (TiN), chromium nitride (CrN), tantalum nitride (TaN), strontium ruthenium oxide (SrRuO), zinc oxide (ZnO), indium tin oxide (ITO), tin oxide (SnO), indium oxide (InO), gallium oxide (GaO), indium zinc oxide (IZO), and the like. These may be used alone or in combination with each other. In an embodiment, the gate electrode GE may have a single-layer structure or a multi-layer structure including a plurality of conductive layers.

The interlayer insulating layer IL may be disposed on the gate electrode GE. Specifically, the interlayer insulating layer IL may be disposed on the gate insulating layer GI and may cover the gate electrode GE thereon. The interlayer insulating layer IL may include an inorganic insulating material. In an embodiment, the interlayer insulating layer IL may be entirely disposed over the display area DA and the peripheral area SA.

The source electrode SE and the drain electrode DE may be disposed on the interlayer insulating layer IL. The source electrode SE and the drain electrode DE may be connected to the active layer ACT, respectively. For example, the source electrode SE may contact the source region of the active layer ACT, and the drain electrode DE may contact the drain region thereof. Each of the source electrode SE and the drain electrode DE may include a conductive material. The active layer ACT, the gate electrode GE, the source electrode SE, and the drain electrode DE may form the transistor TR.

The first via layer VIA1 may be disposed on the source electrode SE and the drain electrode DE. Specifically, the first via layer VIA1 may be disposed on the interlayer insulating layer IL and may cover the source electrode SE and the drain electrode DE on the interlayer insulating layer IL. The first via layer VIA1 may include an organic insulating material. In an embodiment, the first via layer VIA1 may be formed in the display area DA and in a portion of the peripheral area SA adjacent to the display area DA.

The connection electrode CNE may be disposed on the first via layer VIA1. The connection electrode CNE may transmit signals transmitted from the transistor TR to the light-emitting element LED. The connection electrode CNE may include metal, alloy, metal nitride, conductive metal oxide, a transparent conductive material, and the like. These may be used alone or in combination with each other. However, the embodiments of the present disclosure are not necessarily limited thereto.

The second via layer VIA2 may be disposed on the connection electrode CNE. Specifically, the second via layer VIA2 may be disposed on the first via layer VIA1 and may cover the connection electrode CNE. The second via layer VIA2 may include substantially the same material as the first via layer VIA1.

The pixel electrode PE may be disposed on the second via layer VIA2. The pixel electrode PE may include a conductive material. The pixel electrode PE may be connected to the drain electrode DE through the connection electrode CNE. Accordingly, the pixel electrode PE may be electrically connected to the transistor TR.

The pixel defining layer PDL may be disposed on the pixel electrode PE. For example, the pixel defining layer PDL may expose at least a portion of the pixel electrode PE. The pixel defining layer PDL may include an inorganic insulating material or an organic insulating material.

The light-emitting layer EL may be disposed on the pixel electrode PE. In an embodiment, the light-emitting layer EL may be disposed inside an opening defined by the pixel defining layer PDL. That is, the light-emitting layer EL may be surrounded by the pixel defining layer PDL. In an embodiment, the light-emitting layer EL may be disposed on the pixel defining layer PDL. The light-emitting layer EL may include at least one of an organic light-emitting material and/or quantum dots. However, the embodiments of the present disclosure are not necessarily limited thereto.

The common electrode CE may be disposed on the light-emitting layer EL. The common electrode CE may be disposed on the pixel defining layer PDL. That is, the common electrode CE may be continuously disposed on both the light-emitting layer EL and the pixel defining layer PDL. The common electrode CE may include a conductive material. The light-emitting layer EL may emit light based on a voltage difference between the pixel electrode PE and the common electrode CE.

The encapsulation layer ENC may be disposed on the common electrode CE. The encapsulation layer ENC may include at least one inorganic encapsulation layer and at least one organic encapsulation layer. In an embodiment, the inorganic encapsulation layer and the organic encapsulation layer may be alternately stacked. For example, the organic encapsulation layer may include a polymer cured material such as polyacrylate, epoxy resin, silicone resin, and the like. For example, the inorganic encapsulation layer may include silicon oxide, silicon nitride, silicon carbide, aluminum oxide, tantalum oxide, hafnium oxide, zirconium oxide, titanium oxide, and the like.

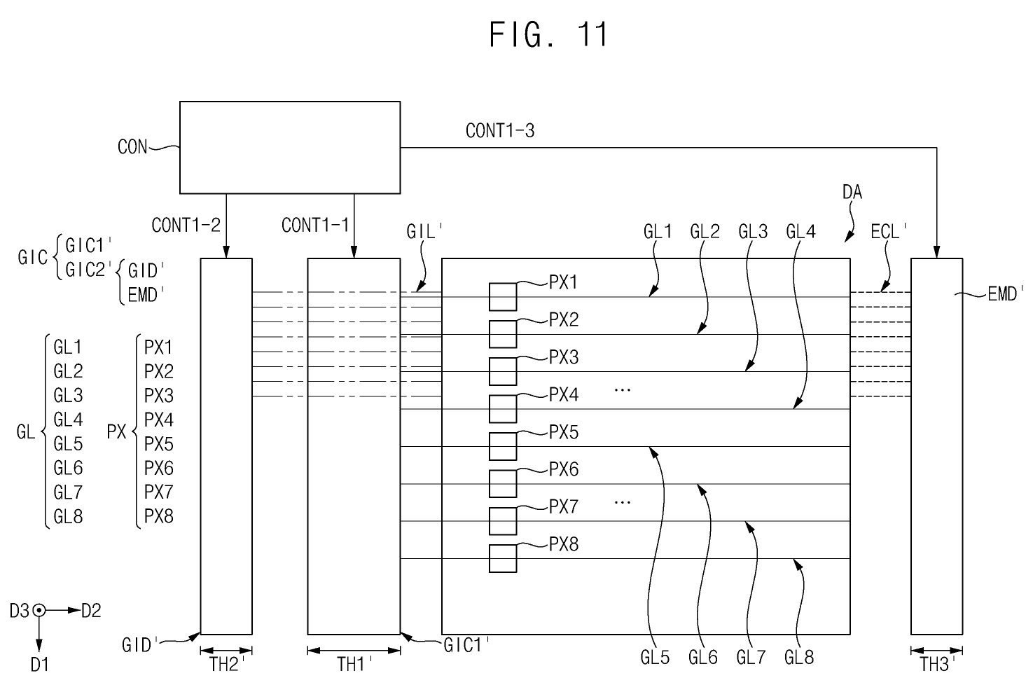

FIG. 11 is a plan view illustrating an embodiment of a gate driver GIC of FIG. 2. Specifically, the description referring to FIG. 11 may be substantially the same as the description referring to FIG. 3, except for the arrangement of the gate initialization part GID and the emission controller EMD. Accordingly, redundant content will be omitted or simplified.

Referring to FIGS. 1, 2 and 11, the peripheral area SA of the display device DD may include a first gate driver GIC1′ and a second gate driver GIC2′. The second gate driver GIC2′ may include a gate initialization part GID′ and an emission controller EMD′. The first control signal CONT1 applied from the driving controller CON may further include a first-third control signal CONT1-3. Specifically, the driving controller CON may apply the first-third control signal CONT1-3 to the emission controller EMD′.

In an embodiment, the gate initialization part GID′ may be disposed spaced apart from the display area DA in an opposite direction of the second direction D2, and the emission controller EMD′ may be disposed spaced apart from the display area DA in the second direction D2. That is, the emission controller EMD′ may be spaced apart in the second direction D2 with the gate initialization part GID' and the display area DA interposed therebetween.

Gate initialization lines GIL’ which extend in the second direction D2 and simultaneously apply gate initialization signals to at least two among the pixels PX may be connected to the gate initialization part GID′. Emission control lines ECL’ which extend in the opposite direction of the second direction D2 and simultaneously apply gate initialization signals to at least two among the pixels PX may be connected to the emission controller EMD′.

In an embodiment, the first gate driver GIC1′ may have a first width TH1′ in the second direction D2, the gate initialization part GID′ may have a second width TH2′ in the second direction D2, and the emission controller EMD′ may have a third width TH3′ in the second direction D2.

For example, the first width TH1′ may be about 850 µm or more and about 900 µm or less, the second width TH2′ may be about 225 µm or more and about 375 µm or less, and the third width TH3′ may be about 225 µm or more and about 375 µm or less. Suitably, the first width TH1′ may be about 800 µm or more and about 900 µm or less, the second width TH2′ may be about 250 µm or more and about 350 µm or less, and the third width TH3′ may be about 250 µm or more and about 350 µm or less.

As the first width TH1′, the second width TH2′, and the third width TH3′ satisfy the above-described ranges, the sum of the first width TH1′, the second width TH2′, and the third width TH3′ may be about 1300 µm or more and about 1650 µm or less.

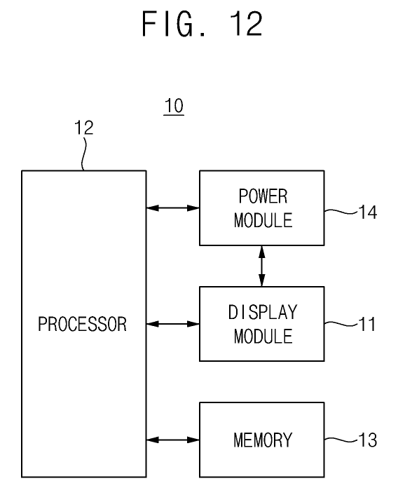

FIG. 12 is a block diagram illustrating an electronic device 10 according to an embodiment of the present disclosure.

Referring to FIGS. 1 and 12, the display device DD according to the embodiments may be applied to various electronic devices 10. In an embodiment, the electronic device 10 includes the above-described display device DD and may further include modules or devices having additional functions other than the display device DD.

The electronic device 10 may include a display module 11, a processor 12, a memory 13, and a power module 14.

The processor 12 may include one or more processors and may include at least one of a central processing unit (CPU), an application processor (AP), a graphic processing unit (GPU), a communication processor (CP), an image signal processor (ISP), and a controller.

The memory 13 may store data information necessary for the operation of the processor 12 or the display module 11. In case that the processor 12 executes the application stored in the memory 13, an image data signal and/or an input control signal may be transmitted to the display module 11, and the display module 11 may process the received signal and output image information through a display screen.

The power module 14 may include a power supply module such as a power adapter or a battery device, and converts the power supplied by the power supply module. Specifically, the power module 14 may include a power conversion module which generates power required for the operation of the electronic device 10.

At least one of each component of the electronic device 10 described above may be included in the display device according to the above-described embodiments. In addition, some of the individual modules functionally included in one module may be included in the display device, and other portions may be provided separately from the display device. For example, the display device may include the display module 11, and the processor 12, the memory 13, and the power module 14 may be provided in the form of other devices within the electronic device 10 other than the display device.

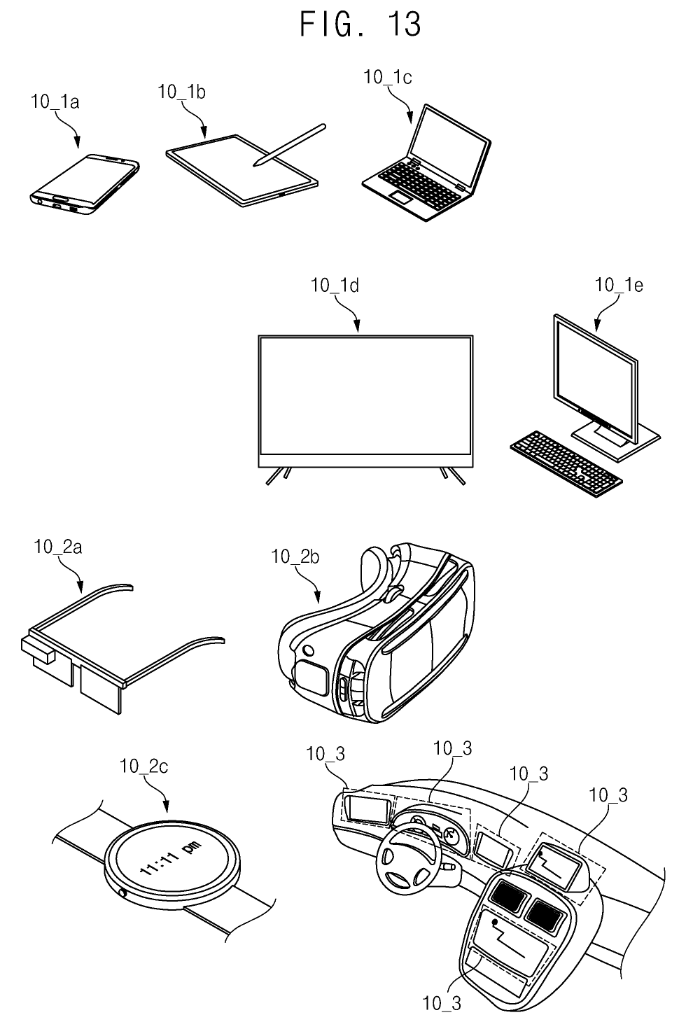

FIG. 13 is a schematic diagram of an electronic device according to various embodiments of FIG. 12.

Referring to FIGS. 12 and 13, various electronic devices 10 to which display devices according to the embodiments are applied may include not only image display electronic devices such as a smartphone 10_1a, a tablet PC 10_1b, a laptop 10_1c, a TV 10_1d, and a desktop monitor 10_1e, but also wearable electronic devices including display modules, such as smart glasses 10_2a, a head-mounted display 10_2b, and a smart watch 10_2c, automotive electronic devices 10_3 including display modules, such as a dashboard of a car, a center fascia, a Center Information Display (CID) disposed on a dashboard, and a room mirror display, or the like.

The present disclosure may be applied to a display device and an electronic device including the same. For example, the present disclosure may be applied to high-resolution smartphones, mobile phones, smart pads, smartwatches, tablet PCs, vehicle navigation systems, televisions, computer monitors, notebook computers, and the like.

While the present disclosure has been described above with reference to the embodiments, it will be understood by those skilled in the art that various modifications and changes can be made thereto without departing from the spirit and scope of the present disclosure as defined by the following claims.

What is claimed is:

1. A display device comprising:
a substrate including a display area and a peripheral area surrounding the display area;
first, second, third, fourth, fifth, sixth, seventh, and eighth pixels disposed in the display area of the substrate, and disposed side by side in a first direction;
a first gate driver disposed in the peripheral area of the substrate, and sequentially applying a gate write signal to each of the first, second, third, fourth, fifth, sixth, seventh, and eighth pixels along the first direction; and
a second gate driver disposed in the peripheral area of the substrate, spaced apart from the first gate driver in a second direction intersecting the first direction, and including:
a gate initialization part simultaneously applying a gate initialization signal to at least two pixels among the first, second, third, fourth, fifth, sixth, seventh, and eighth pixels; and
an emission controller simultaneously applying an emission control signal to at least two pixels among the first, second, third, fourth, fifth, sixth, seventh, and eighth pixels, and disposed adjacent to the gate initialization part in the first direction.

2. The display device of claim 1, wherein the gate initialization part includes an initialization signal controller and first, second, third, fourth, fifth, sixth, seventh, and eighth initialization signal output parts connected to the initialization signal controller, and
wherein the emission controller includes an emission signal controller and first, second, third, fourth, fifth, sixth, seventh, and eighth emission signal output parts connected to the emission signal controller.

3. The display device of claim 2, further comprising:
first, second, third, fourth, fifth, sixth, seventh, and eighth gate initialization lines extending in an opposite direction of the second direction from the gate initialization part, respectively being connected to the first, third, fourth, fifth, sixth, seventh, and eighth initialization signal output parts, and simultaneously applying the gate initialization signal to the first, second, third, fourth, fifth, sixth, seventh, and eighth pixels; and
first, second, third, fourth, fifth, sixth, seventh, and eighth emission control lines extending in the opposite direction of the second direction from the emission controller, respectively being connected to the first, third, fourth, fifth, sixth, seventh, and eighth emission signal output parts, and simultaneously applying the emission control signal to the first, second, third, fourth, fifth, sixth, seventh, and eighth pixels.

4. The display device of claim 1, further comprising:
a first clock line disposed in the peripheral area of the substrate and applying a first clock signal to the gate initialization part; and
a second clock line disposed in the peripheral area of the substrate and applying a second clock signal to the gate initialization part.

5. The display device of claim 4, wherein the first clock line and the second clock line are electrically connected to the emission controller.

6. The display device of claim 4, further comprising:
a third clock line disposed in the peripheral area of the substrate and applying a third clock signal to the emission controller; and
a fourth cock line disposed in the peripheral area of the substrate and applying a fourth clock signal to the emission controller.

7. The display device of claim 1, further comprising:
a first voltage line disposed in the peripheral area of the substrate and applying a first voltage to the gate initialization part; and
a second voltage line disposed in the peripheral area of the substrate and applying a second voltage to the gate initialization part.

8. The display device of claim 7, wherein the first voltage line and the second voltage line are electrically connected to the emission controller.

9. The display device of claim 7, further comprising:
a third voltage line disposed in the peripheral area of the substrate and applying a third voltage to the emission controller; and
a fourth voltage line disposed in the peripheral area of the substrate and applying a fourth voltage to the emission controller.

10. The display device of claim 1, wherein the gate initialization part includes an initialization signal controller and first, second, third, and fourth initialization signal output parts connected to the initialization signal controller, and
wherein the emission controller includes an emission signal controller and first, second, third, and fourth emission signal output parts connected to the emission signal controller.

11. The display device of claim 10, further comprising:
first, second, third, and fourth gate initialization lines extending in an opposite direction of the second direction from the gate initialization part, respectively being connected to the first, second, third, and fourth initialization signal output parts, and simultaneously applying the gate initialization signal to the first, second, third, and fourth pixels; and
first, second, third, and fourth emission control lines extending in the opposite direction of the second direction from the emission controller, respectively being connected to the first, second, third, and fourth emission signal output parts, and simultaneously applying the emission control signal to the first, second, third, and fourth pixels.

12. The display device of claim 1, wherein the first gate driver has a first width in the second direction,
the second gate driver has a second width in the second direction, and
a sum of the first width and the second width is 1300 um or more and 1650 um or less.

13. The display device of claim 12, wherein the first width is 450 um or more and 750 um or less.

14. A display device comprising:
a substrate including a display area and a peripheral area surrounding to the display area;
first, second, third, fourth, fifth, sixth, seventh, and eighth pixels disposed in the display area of the substrate, and disposed side by side in a first direction;
a gate driver disposed in the peripheral area of the substrate, and sequentially applying a gate write signal to each of the first, second, third, fourth, fifth, sixth, seventh, and eighth pixels;
a gate initialization part disposed in the peripheral area of the substrate, spaced apart from the gate driver in a second direction interesting the first direction, and simultaneously applying a gate initialization signal to at least two pixels among the first, second, third, fourth, fifth, sixth, seventh, and eighth pixels; and
an emission controller disposed in the peripheral area of the substrate, spaced apart from the gate driver with the display area interposed between the emission controller and the gate driver, and simultaneously applying an emission control signal to at least two pixels among the first, second, third, fourth, fifth, sixth, seventh, and eighth pixels.

15. The display device of claim 14, wherein the gate initialization part includes an initialization signal controller and first, second, third, fourth, fifth, sixth, seventh, and eighth initialization signal output parts connected to the initialization signal controller, and
wherein the emission controller includes an emission signal controller and first, second, third, fourth, fifth, sixth, seventh, and eighth emission signal output parts connected to the emission signal controller.

16. The display device of claim 15, further comprising:
first, second, third, fourth, fifth, sixth, seventh, and eighth gate initialization lines extending in an opposite direction of the second direction from the gate initialization part, respectively being connected to the first, third, fourth, fifth, sixth, seventh, and eighth initialization signal output parts, and simultaneously applying the gate initialization signal to the first, second, third, fourth, fifth, sixth, seventh, and eighth pixels; and
first, second, third, fourth, fifth, sixth, seventh, and eighth emission control lines extending in the opposite direction of the second direction from the emission controller, respectively being connected to the first, third, fourth, fifth, sixth, seventh, and eighth emission signal output parts, and simultaneously applying the emission control signal to the first, second, third, fourth, fifth, sixth, seventh, and eighth pixels.

17. The display device of claim 14, wherein the gate initialization part includes an initialization signal controller and first, second, third, and fourth initialization signal output parts connected to the initialization signal controller, and
wherein the emission controller includes an emission signal controller and first, second, third, and fourth emission signal output parts connected to the emission signal controller.

18. The display device of claim 17, further comprising:
first, second, third, and fourth gate initialization lines extending in an opposite direction of the second direction from the gate initialization part, respectively being connected to the first, second, third, and fourth initialization signal output parts, and simultaneously applying the gate initialization signal to the first, second, third, and fourth pixels; and
first, second, third, and fourth emission control lines extending in the opposite direction of the second direction from the emission controller, respectively being connected to the first, second, third, and fourth emission signal output parts, and simultaneously applying the emission control signal to the first, second, third, and fourth pixels.

19. The display device of claim 14, wherein the gate driver has a first width in the second direction,
the gate initialization part has a second width in the second direction,
the emission controller has a third width in the second direction, and
a sum of the first width, the second width, and the third width is 1300 um or more and 1650 um or less.

20. An electronic device comprising:
a display device; and
one or more processors driving the display device,
wherein the display device includes:
a substrate including a display area and a peripheral area surrounding to the display area;
first, second, third, fourth, fifth, sixth, seventh, and eighth pixels disposed in the display area of the substrate, and disposed side by side in a first direction;
a first gate driver disposed in the peripheral area of the substrate, and sequentially applying a gate write signal to each of the first, second, third, fourth, fifth, sixth, seventh, and eighth pixels along the first direction; and
a second gate driver disposed in the peripheral area of the substrate, spaced apart from the first gate driver in a second direction intersecting the first direction, and including:
a gate initialization part simultaneously applying a gate initialization signal to at least two pixels among the first, second, third, fourth, fifth, sixth, seventh, and eighth pixels; and
an emission controller simultaneously applying an emission control signal to at least two pixels among the first, second, third, fourth, fifth, sixth, seventh, and eighth pixels, and disposed adjacent to the gate initialization part in the first direction.
